(19) United States
(12) Patent Application Publication
(10) Pub. No.: US 2024/0005005 A1
(43) Pub. Date: Jan. 4, 2024

(54) ELECTRONIC DEVICE AND CONTROL METHOD THEREOF

(71) Applicant: Sigmastar Technology Ltd., Xiamen (CN)

(72) Inventors: Qin-Wei She, Xiamen (CN); Yan-Xiong Wu, Xiamen (CN); Xiao-Min Zhang, Xiamen (CN)

(21) Appl. No.: 18/204,402

(22) Filed: Jun. 1, 2023

(30) Foreign Application Priority Data
Jun. 29, 2022 (CN) 202210756239.6

(51) Int. Cl. G06F 21/57; G06F 21/62

(52) U.S. Cl. CPC G06F 21/575; G06F 21/62

(57) ABSTRACT

An electronic device and a control method thereof are provided. The electronic device includes a read-only memory (ROM) that stores a first characteristic value of a public key. The control method includes the following steps: reading the public key and a plurality of boot codes of the electronic device from an external storage device; executing the boot codes; and verifying the public key according to the first characteristic value. The public key is used to verify the boot codes, and the number of bits of the first characteristic value is smaller than the number of bits of the public key. The ROM is disposed on a first chip, and the external storage device is disposed on a second chip.

This application claims the benefit of China application Serial No. 202210756239.6, filed on Jun. 29, 2022, the subject matter of which is incorporated herein by reference.

### BACKGROUND OF THE INVENTION

### 1. Field of the Invention

The present invention generally relates to electronic devices, and, more particularly, to a boot flow and a control method of the electronic devices.

### 2. Description of Related Art

FIG. 1 shows a schematic diagram of the boot flow of an electronic device running a Linux system. The boot flow mainly includes the following boot procedures: the read-only memory (ROM) boot 110, the Miniboot 120, the U-boot 130, and the Kernel 140. Since the ROM boot, Miniboot, U-boot, and Kernel are well known to people having ordinary skill in the art, the details are omitted for brevity.

In order to prevent the boot codes (i.e., firmware) from being tampered with, the ROM boot 110 uses the public key 122 and the signature 124 to verify the Miniboot 120, and the Miniboot 120 uses the public key 122 and the signature 132 to verify the U-boot 130. The signature 124 and the signature 132 are the data generated by using a private key to sign the boot codes (i.e., the Miniboot 120 and U-boot 130), and the private key and the public key 122 are a pair of keys.

In the conventional method, the public key 122 is stored in a protected storage medium to prevent the public key 122 from being tampered with. The disadvantage of the conventional method is that the size of the public key 122 significantly affects the cost of the electronic product (the greater the size of the public key 122, the greater the storage medium required, hence higher cost).

### SUMMARY OF THE INVENTION

In view of the issues of the prior art, an object of the present invention is to provide an electronic device and a control method thereof, so as to make an improvement to the prior art.

According to one aspect of the present invention, an electronic device is provided. The electronic device accesses an external storage device that stores a plurality of boot codes of the electronic device and a public key. The electronic device includes a read-only memory, a computing circuit, and an encryption and decryption circuit. The read-only memory is configured to store a first characteristic value of the public key. The computing circuit is configured to execute the boot codes. The encryption and decryption circuit is configured to perform a verification procedure on the public key according to the first characteristic value. The public key is used to verify the boot codes, and the number of bits of the first characteristic value is smaller than the number of bits of the public key. The read-only memory, the computing circuit, and the encryption and decryption circuit are disposed on a first chip, and the external storage device is disposed on a second chip.

According to another aspect of the present invention, a method of controlling an electronic device is provided. The electronic device includes a read-only memory that stores a first characteristic value of a public key. The method includes the following steps: reading a plurality of boot codes of the electronic device and the public key from an external storage device; executing the boot codes; and performing a verification procedure on the public key according to the first characteristic value. The public key is used to verify the boot codes, and the number of bits of the first characteristic value is smaller than the number of bits of the public key. The read-only memory is disposed on a first chip, and the external storage device is disposed on a second chip.

The technical means embodied in the embodiments of the present invention can solve at least one of the problems of the prior art. Therefore, the present invention can reduce cost compared with the prior art.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 shows a schematic diagram of a conventional boot flow of an electronic device running a Linux system.

FIG. 2 is a functional block diagram of an electronic device according to an embodiment of the present invention.

FIG. 3 is a flowchart of a method of controlling an electronic device according to an embodiment of the present invention.

FIG. 4 shows a flowchart of a boot flow of the electronic device according to an embodiment of the present invention.

FIG. 5 is a flowchart of a signature verification process according to an embodiment of the present invention.

FIG. 6 is a schematic diagram of a one-time programmable (OTP) read-only memory (ROM) according to an embodiment of the present invention.

FIG. 7 is a flowchart of burning control according to an embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes an electronic device and a control method thereof. On account of that some or all elements of the electronic device could be known, the detail of such elements is omitted provided that such detail has little to do with the features of this disclosure, and that this omission nowhere dissatisfies the specification and enablement requirements. Some or all of the processes of the method of controlling the electronic device may be implemented by software and/or firmware and can be performed by the electronic device or its equivalent. A person having ordinary skill in the art can choose components or steps equivalent to those described in this specification to carry out the present invention, which means that the scope of this invention is not limited to the embodiments in the specification.

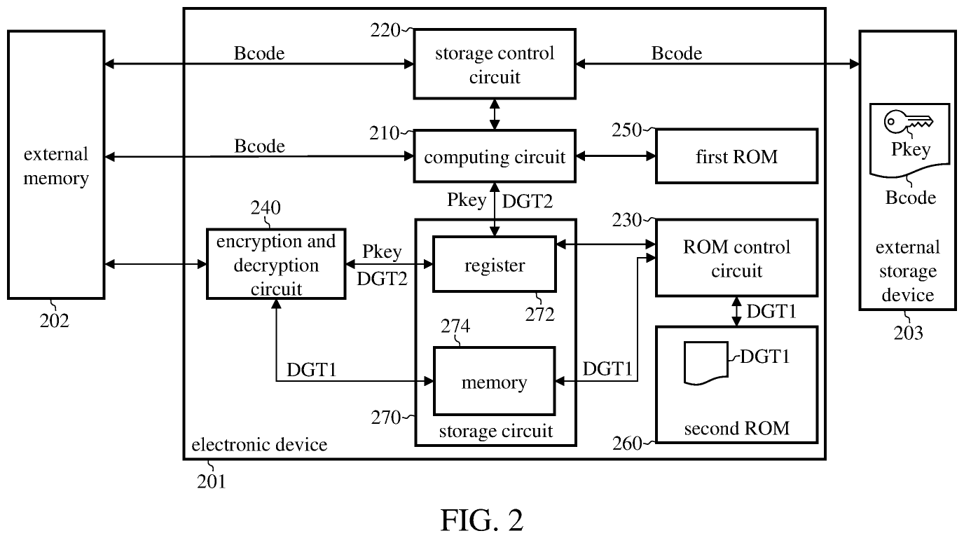

FIG. 2 is a functional block diagram of an electronic device according to an embodiment of the present invention. The electronic device 201 is coupled to an external memory 202 (e.g., a dynamic random-access memory (DRAM)) and an external storage device 203 (e.g., a flash memory, embedded multimedia card (eMMC), or secure digital (SD) memory card). The external storage device 203 stores the public key Pkey and the boot codes Bcode (i.e., the firmware related to the boot procedures of the electronic device 201) of the electronic device 201.

The electronic device 201 includes a computing circuit 210, a storage control circuit 220, a ROM control circuit 230, an encryption and decryption circuit 240, a first ROM 250, a second ROM 260, and a storage circuit 270. The storage circuit 270 includes a register 272 and a memory 274 (e.g., a static random-access memory (SRAM)). In one embodiment, the electronic device 201 is a chip in which the computing circuit 210, the storage control circuit 220, the ROM control circuit 230, the encryption and decryption circuit 240, the first ROM 250, the second ROM 260, and the storage circuit 270 are disposed, whereas the external memory 202 and the external storage device 203 are each a separate chip.

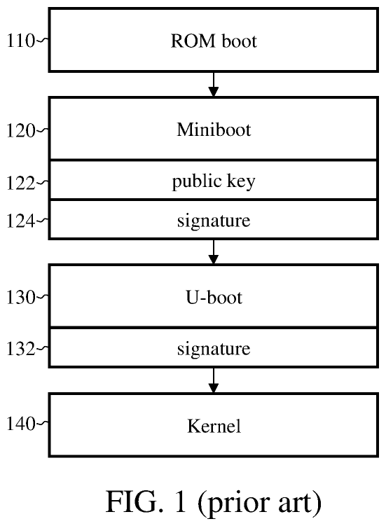

In some embodiments, the boot codes Bcode include the parts in FIG. 1 other than the ROM boot (where the public key Pkey may correspond to the public key 122), while the ROM boot is stored in the first ROM 250. Program codes associated with the Miniboot, U-boot, and Kernel can be stored in the external storage device 203 in the form of image files. The storage control circuit 220 can read the boot codes Bcode from the external storage device 203 at a proper time and store the boot codes Bcode in the external memory 202. The computing circuit 210 and the encryption and decryption circuit 240 can access the external memory 202 to obtain the boot codes Bcode. The boot codes Bcode are executed by the computing circuit 210. The computing circuit 210 can control the ROM control circuit 230 and the encryption and decryption circuit 240 by changing the register value of the register 272.

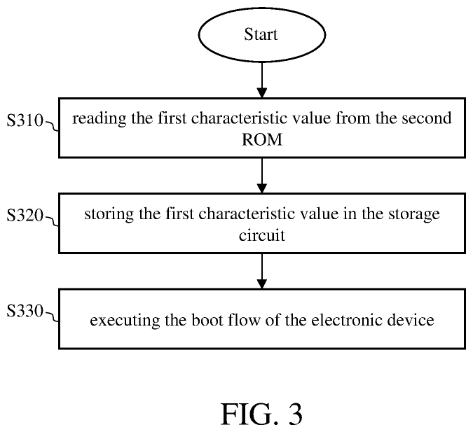

FIG. 3 is a flowchart of a method of controlling an electronic device according to an embodiment of the present invention. The method includes the following steps.

Step S310: The ROM control circuit 230 reads the first characteristic value DGT1 from the second ROM 260.

Step S320: The ROM control circuit 230 stores the first characteristic value DGT1 in the storage circuit 270, for example, in the memory 274.

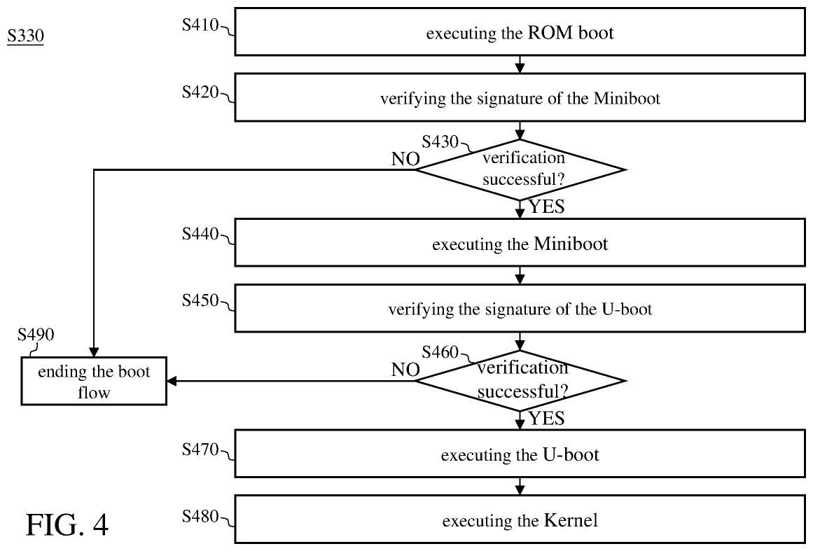

Step S330: The computing circuit 210 executes the boot flow of the electronic device 201. The boot flow of the electronic device 201 will be discussed in detail below with reference to FIG. 4.

As shown in FIG. 3, the first characteristic value DGT1 is read from the second ROM 260 (step S310) and stored in the storage circuit 270 (step S320) before the booting of the electronic device 201 (step S330). More specifically, the ROM control circuit 230 is designed to automatically perform step S310 and step S320 once the electronic device 201 is powered on or turned on. Because the first characteristic value DGT1 plays a key role in the boot flow of the electronic device 201 (which will be discussed in detail below), ensuring that the first characteristic value DGT1 is ready to use before the boot flow starts can improve the smoothness and stability of the boot flow.

FIG. 4 shows a flowchart of a boot flow of the electronic device according to an embodiment of the present invention. Reference is made to both FIG. 2 and FIG. 4 for the following discussions.

Step S410: The computing circuit 210 executes the ROM boot. More specifically, the computing circuit 210 reads the ROM boot from the first ROM 250 and executes the ROM boot. In one embodiment, the ROM boot codes include instructions or codes for initiating the public key verification and Miniboot signature verification, and when executing the instructions or codes for initiating the public key verification and the Miniboot signature verification, the computing circuit 210 sends a control instruction to the encryption and decryption circuit 240 to start the verification process. In one embodiment, the ROM boot codes also include instructions or codes for reading the Miniboot codes from the external storage device 203 to a memory of the electronic device 201; the memory, for example, may be included in the storage circuit 270.

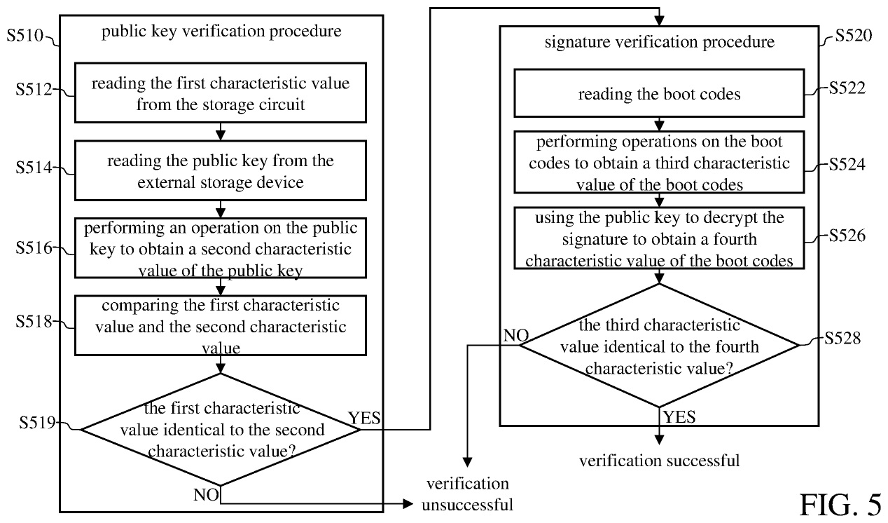

Step S420: The computing circuit 210 and the encryption and decryption circuit 240 verify the signature of the Miniboot. The signature verification process will be discussed in detail below with reference to FIG. 5.

Step S430: Determining whether the verification is successful (being successful means that the signature is authentic, that is, the Miniboot has not been tampered with; being unsuccessful means that the public key Pkey and/or the signature are/is inauthentic, that is, the boot codes Bcode and/or the public key Pkey may have been tampered with). If the verification is successful, the boot flow proceeds to step S440; otherwise, the boot flow ends (step S490).

Step S440: The computing circuit 210 executes the Miniboot, that is, the computing circuit 210 reads the Miniboot from the memory of the electronic device 201 and then executes it. In one embodiment, the codes of the Miniboot include instructions or codes for initializing the external memory 202, and the process of executing the Miniboot by the computing circuit 210 includes the operation of initializing the external memory 202.

Step S450: The computing circuit 210 and the encryption and decryption circuit 240 verify the signature of the U-boot. The signature verification process will be discussed in detail below in connection with FIG. 5.

Step S460: Determining whether the verification is successful. If the verification is successful (meaning that the U-boot has not been tampered with), then the boot flow proceeds to step S470; otherwise, the boot flow ends (step S490).

Step S470: The computing circuit 210 executes the U-boot, that is, the computing circuit 210 reads the U-boot from the external memory 202 and executes it.

Step S480: The computing circuit 210 executes the Kernel, that is, the computing circuit 210 reads the Kernel from the external memory 202 and executes it.

Step S490: The boot flow ends, that is, the computing circuit 210 stops executing the boot flow.

In one embodiment, the signature of the Kernel is verified using the computing circuit 210 and the encryption and decryption circuit 240 before step S480; the Kernel is executed only when no modification to the Kernel is confirmed.

FIG. 5 is a flowchart of the signature verification process according to an embodiment of the present invention. The flow mainly includes a public key verification procedure S510 and a signature verification procedure S520. Reference is made to both FIG. 2 and FIG. 5 in the following discussion.

The public key verification procedure S510 includes the following steps.

Step S512: The encryption and decryption circuit 240 reads the first characteristic value DGT1 from the memory 274 of the storage circuit 270. The first characteristic value DGT1 has been stored in the storage circuit 270 before the boot flow (step S320). In one embodiment, in order to enhance security, only the encryption and decryption circuit 240 in the electronic device 201 can control the ROM control circuit 230 to read the first characteristic value DGT1 from the second ROM, and the computing circuit 210 does not know the position of the first characteristic value DGT1 and hence cannot read the first characteristic value DGT1.

Step S514: The computing circuit 210 reads the public key Pkey from the external storage device 203 and stores the public key Pkey into the register 272 of the storage circuit 270.

Step S516: The computing circuit 210 performs a characteristic value operation on the public key Pkey based on a first characteristic value operation method to obtain a second characteristic value DGT2 of the public key Pkey and stores the second characteristic value DGT2 in the register 272 of the storage circuit 270. In one embodiment, the characteristic value operation can be performed on the public key Pkey by the encryption and decryption circuit 240 to obtain the second characteristic value DGT2 of the public key Pkey. Before delivery of the electronic device 201, the manufacturer of the electronic device 201 uses the first characteristic value operation method to perform the characteristic value operation on the public key Pkey to obtain the first characteristic value DGT1 and stores the first characteristic value DGT1 in the second ROM 260 through the ROM control circuit 230. In some embodiments, the first characteristic value operation method includes, but not limited to, a hash algorithm (also referred to as a hash function); other characteristic value operation methods are also applicable to this disclosure. The length (i.e., the number of bits) of the first characteristic value DGT1 is smaller than the length of the public key Pkey.

Step S518: The encryption and decryption circuit 240 reads the second characteristic value DGT2 from the register 272 of the storage circuit 270 and compares the first characteristic value DGT1 and the second characteristic value DGT2.

Step S519: The encryption and decryption circuit 240 determines whether the first characteristic value DGT1 is identical to the second characteristic value DGT2. If the first characteristic value DGT1 is identical to the second characteristic value DGT2, the flow proceeds to the signature verification procedure S520; otherwise, the encryption and decryption circuit 240 determines that the signature verification is unsuccessful.

Since the first characteristic value DGT1 of the public key Pkey is the outcome of the operation of the public key Pkey based on the first characteristic value operation method (that is to say, the first characteristic value DGT1 can represent the public key Pkey to some extent), the result of step S519 should be YES if neither the first characteristic value DGT1 nor the second characteristic value DGT2 has been tampered with. However, if any one of the first characteristic value DGT1 and the second characteristic value DGT2 has been tampered with (that is to say, it is likely that the electronic device 201 and/or the external storage device 203 have/has been maliciously attacked), the computing circuit 210 should stop executing the boot flow of the electronic device 201. Therefore, when the result of step S519 is NO, the encryption and decryption circuit 240 notifies the computing circuit 210 through the register 272 that the public key Pkey is inauthentic and skips the signature verification procedure S520. When the public key Pkey is inauthentic, the signature verification procedure S520 will definitely be unsuccessful. Therefore, the computing circuit 210 can directly determine that the signature verifications are unsuccessful (i.e., the results of step S430 and step S460 are NO) based on the public key Pkey being inauthentic and hence ends the boot flow (step S490).

The signature verification procedure S520 includes the following steps.

Step S522: The encryption and decryption circuit 240 reads the boot codes Bcode. More specifically, if step S420 is being executed, the encryption and decryption circuit 240 reads the program codes related to the Miniboot from the storage circuit 270 at this step; if step S450 is being executed, the encryption and decryption circuit 240 reads the program codes related to the U-boot from the external memory 202 at this step.

Step S524: The encryption and decryption circuit 240 uses the second characteristic value operation method to perform operations on the boot codes Bcode to obtain a third characteristic value of the boot codes Bcode. In some embodiments, the second characteristic value operation method is the same as the first characteristic value operation method.

Step S526: The encryption and decryption circuit 240 uses the public key Pkey to decrypt the signature to obtain a fourth characteristic value of the boot codes Bcode. More specifically, if step S420 is being executed, the encryption and decryption circuit 240 decrypts the signature of the Miniboot (e.g., the signature 124 in FIG. 1) at this step; if step S450 is being executed, the encryption and decryption circuit 240 decrypts the signature of the U-boot (e.g., the signature 132 in FIG. 1) at this step. If the boot codes Bcode has not been tampered with, the third characteristic value should be identical to the fourth characteristic value.

Step S528: The encryption and decryption circuit 240 determines whether the third characteristic value is identical to the fourth characteristic value. When the third characteristic value is not identical to the fourth characteristic value (which means that at least one of the Miniboot (or U-boot) and its signature has been tampered with), the computing circuit 210 should stop executing the boot flow. Therefore, when the result of step S528 is NO, the encryption and decryption circuit 240 notifies, through the register 272, the computing circuit 210 that the signature verification is unsuccessful. The result of step S528 being YES indicates that the signature verification is successful.

To sum up, because it is the characteristic value of the public key Pkey (rather than the public key Pkey itself) that is stored in the second ROM 260, and the length of the characteristic value is smaller than the length of the public key Pkey, the present invention can use a smaller second ROM 260 (that is to say, the cost of the electronic device 201 can be reduced). For example, if the public key Pkey is a public key of the RSA2048 encryption algorithm or the RSA4096 encryption algorithm, the length of the public key Pkey is 2048 bits or 4096 bits; however, when the first characteristic value DGT1 is the result of the hash function SHA-256, the length of the first characteristic value DGT1 is 256 bits, which is only ⅛ or 1/16 of 2048 bits or 4096 bits, greatly reducing the requirements for the second ROM 260.

In some embodiments, the second ROM 260 may be an OTP ROM (e.g., OTP memory or electrically programmable fuse (eFuse)). Since an OTP ROM can prevent data from being tampered with, the authenticity of the first characteristic value DGT1 can be further ensured. When the second ROM 260 is embodied by an OTP ROM, storing the characteristic value of the public key Pkey (rather than the public key Pkey itself) can also improve the success rate of burning the second ROM 260 (which in turn improves the yield rate of the electronic device 201); this is because the number of bits of the characteristic value is smaller than the number of bits of the public key Pkey (the smaller the number of bits of the data for burning, the higher the success rate of burning).

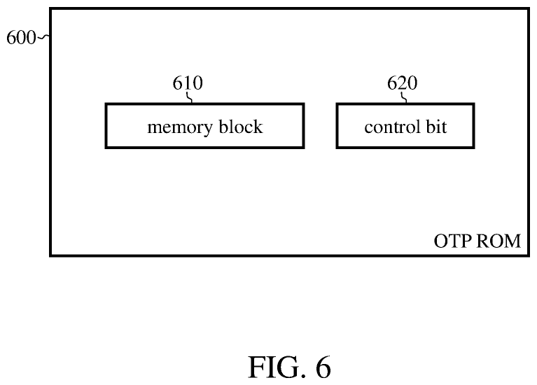

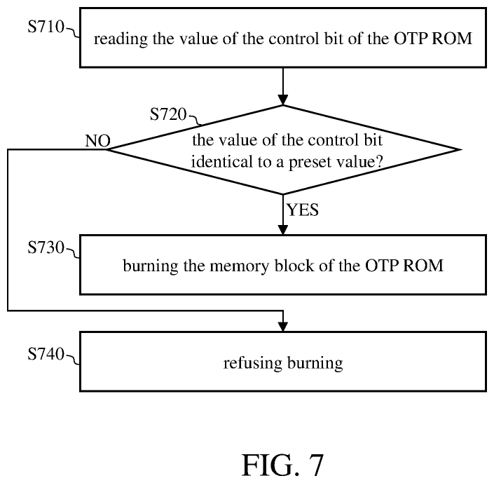

FIG. 6 is a schematic diagram of an OTP ROM according to an embodiment of the present invention. The OTP ROM 600 includes a memory block 610 and a control bit 620. The memory block 610 can store the aforementioned first characteristic value DGT1, and the control bit 620 is indicative of whether the memory block 610 can be burned. When the second ROM 260 is embodied by an OTP ROM 600, the ROM control circuit 230 determines whether to burn the memory block 610 according to the value of the control bit 620. For example, only when the value of the control bit 620 is 0, the ROM control circuit 230 can burn the memory block 610. When the second ROM 260 is embodied by the OTP ROM 600 shown in FIG. 6, the control method of the electronic device of the present invention further includes burning control of the second ROM 260. The flow of burning control is shown in FIG. 7, including the following steps.

Step S710: Before burning the memory block 610, the ROM control circuit 230 reads the value of the control bit 620.

Step S720: Determining whether the value of the control bit 620 is identical to a preset value (e.g., bit 0). If the result is YES, the flow proceeds to step S730; otherwise, the flow proceeds to step S740.

Step S730: The ROM control circuit 230 burns the memory block 610.

Step S740: The ROM control circuit 230 refuses to burn the memory block 610.

Many OTP ROMs are burned in the unit of one bit. For example, if the value of the memory block 610 after burning is “11111010,” the 0th and 2nd bits of this value can be further burned into 1, but other bits cannot be burned again into 0. The burning control of FIG. 7 can prevent the data of the memory block 610 from being tampered with or maliciously damaged (e.g., secondary burning).

In some embodiments, when the first characteristic value operation method is a hash algorithm (e.g., a cryptographic hash function), both the first characteristic value DGT1 and the second characteristic value DGT2 are the hash values (i.e., the outcome of the hash algorithm, also referred to as message digest or digest) of the public key Pkey. Because a hash value is quite unique, a portion of the hash value (e.g., the first half or the second half of the hash value) is sufficient to represent the public key Pkey. In other words, the second ROM 260 can store only a portion of the first characteristic value DGT1 to further reduce the cost of the electronic device 201 and improve the success rate of burning the OTP ROM 600. When the second ROM 260 stores only a portion of the first characteristic value DGT1, in step S518 the encryption and decryption circuit 240 compares that portion of the first characteristic value DGT1 with a corresponding portion of the second characteristic value DGT2.

The computing circuit 210 may be a circuit or an electronic component capable of executing programs, such as a central processing unit, a microprocessor, a microcontroller, a micro-processing unit, a digital signal processor (DSP) or their equivalent circuits. In other embodiments, people having ordinary skill in the art can design the computing circuit 210 according to the above discussions; that is, the computing circuit 210 can be an application specific integrated circuit (ASIC) or embodied by circuits or hardware such as a programmable logic device (PLD).

In some embodiments, the electronic device 201 is a chip, and the electronic device 201, the external memory 202, and the external storage device 203 form an embedded system.

The embedded system of the present invention stores the public key Pkey and its first characteristic value DGT1 at the same time, which enables the electronic device 201 to effectively know whether the embedded system is facing a malicious attack of fault injection. This is because a malicious attack of fault injection on the embedded system changes both the public key Pkey and the first characteristic value DGT1, which definitely leads to a failure in the public key verification procedure S510.

Although the foregoing embodiments take the boot flow of an electronic device as an example, this is not a limitation to the present invention. Based on the disclosure of the present invention, people having ordinary skill in the art can apply the present invention to signature verification procedures for other types of data.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. An electronic device that accesses an external storage device that stores a plurality of boot codes of the electronic device and a public key, the electronic device comprising:
a read-only memory configured to store a first characteristic value of the public key;
a computing circuit configured to execute the boot codes; and
an encryption and decryption circuit configured to perform a verification procedure on the public key according to the first characteristic value;
wherein the public key is used to verify the boot codes, and the number of bits of the first characteristic value is smaller than the number of bits of the public key;
wherein the read-only memory, the computing circuit, and the encryption and decryption circuit are disposed on a first chip, and the external storage device is disposed on a second chip.

2. The electronic device of claim 1, wherein the external storage device further stores a signature that is related to the boot codes, and when the verification procedure is successful, the encryption and decryption circuit uses the public key to decrypt the signature.

3. The electronic device of claim 1 further comprising:
a storage circuit; and
a read-only memory control circuit configured to read the first characteristic value from the read-only memory and store the first characteristic value in the storage circuit before the computing circuit executes the boot codes.

4. The electronic device of claim 1, wherein the encryption and decryption circuit verifies the public key by comparing the first characteristic value with a second characteristic value obtained by performing an operation on the public key.

5. The electronic device of claim 4, wherein the first characteristic value is a first hash value of the public key, and the second characteristic value is a second hash value of the public key.

6. The electronic device of claim 4, wherein the first characteristic value is a portion of a first hash value of the public key, and the second characteristic value is a portion of a second hash value of the public key.

7. The electronic device of claim 1, wherein the read-only memory is a one-time programmable read-only memory.

8. The electronic device of claim 7 further comprising:
a read-only memory control circuit configured to control the one-time programmable read-only memory;
wherein the read-only memory control circuit checks a value of a control bit of the one-time programmable read-only memory before the one-time programmable read-only memory is burned, and the control bit is indicative of whether a memory block storing the first characteristic value can be burned.

9. The electronic device of claim 1, wherein when the verification procedure is unsuccessful, the computing circuit stops executing the boot codes.

10. A method of controlling an electronic device, the electronic device comprising a read-only memory that stores a first characteristic value of a public key, the method comprising:
reading a plurality of boot codes of the electronic device and the public key from an external storage device;
executing the boot codes; and
performing a verification procedure on the public key according to the first characteristic value;
wherein the public key is used to verify the boot codes, and the number of bits of the first characteristic value is smaller than the number of bits of the public key;
wherein the read-only memory is disposed on a first chip, and the external storage device is disposed on a second chip.

11. The method of claim 10, wherein the external storage device stores a signature that is related to the boot codes, the method further comprising:
using the public key to decrypt the signature when the verification procedure is successful.

12. The method of claim 10, wherein the electronic device further comprises a storage circuit, the method further comprising:
reading the first characteristic value from the read-only memory and storing the first characteristic value in the storage circuit before executing the boot codes.

13. The method of claim 10 further comprising:
verifying the public key by comparing the first characteristic value with a second characteristic value obtained by performing an operation on the public key.

14. The method of claim 13, wherein the first characteristic value is a first hash value of the public key, and the second characteristic value is a second hash value of the public key.

15. The method of claim 13, wherein the first characteristic value is a portion of a first hash value of the public key, and the second characteristic value is a portion of a second hash value of the public key.

16. The method of claim 10, wherein the read-only memory is a one-time programmable read-only memory.

17. The method of claim 16 further comprising:
checking a value of a control bit of the one-time programmable read-only memory before the one-time programmable read-only memory is burned, wherein the control bit is indicative of whether a memory block storing the first characteristic value can be burned.

18. The method of claim 10 further comprising:
stopping executing the boot codes when the verification procedure is unsuccessful.

19. The method of claim 10, wherein the step of performing the verification procedure on the public key according to the first characteristic value is executed before a Miniboot boot procedure or a U-boot boot procedure of the boot codes.
